(19) United States
(12) Patent Application Publication
(10) Pub. No.: US 2012/0113146 A1
(43) Pub. Date: May 10, 2012

(54) METHODS, APPARATUS AND ARTICLES OF MANUFACTURE TO COMBINE SEGMENTATIONS OF MEDICAL DIAGNOSTIC IMAGES

(76) Inventor: Patrick Michael Virtue, Albany, CA (US)

(21) Appl. No.: 12/943,542

(22) Filed: Nov. 10, 2010

(51) Int. Cl. G09G 5/00

(52) U.S. Cl. 345/634

(57) ABSTRACT

Example methods, apparatus and articles of manufacture to combine segmentations of medical diagnostic images are disclosed. A disclosed example method includes presenting a user interface displaying a first segmentation of a first diagnostic image together with a second segmentation of a second diagnostic image, identifying one or more regions defined by one or more logical combinations of the first and second segmentations, receiving from a user a selection of a first of the regions, and emphasizing the first region in the user interface.

### FIELD OF THE DISCLOSURE

This disclosure relates generally to medical diagnostic images and, more particularly, to methods, apparatus and articles of manufacture to combine segmentations of medical diagnostic images.

### BACKGROUND

A widely used medical diagnostic technique includes the automated segmentation of diagnostic images to assist in the diagnosis of medical conditions. Example segmentations include, but are not limited to, the automated identification of joint cartilage and/or heart wall.

### BRIEF DESCRIPTION OF THE INVENTION

Example methods, apparatus and articles of manufacture to combine segmentations of medical diagnostic images are disclosed. A disclosed example method includes presenting a user interface displaying a first segmentation of a first diagnostic image together with a second segmentation of a second diagnostic image, identifying one or more regions defined by one or more logical combinations of the first and second segmentations, receiving from a user a selection of a first of the regions, and emphasizing the first region in the user interface.

A disclosed example apparatus includes a display to present a user interface displaying a first segmentation of a first diagnostic image together with a second segmentation of a second diagnostic image, a region identifier to identify one or more regions defined by one or more logical combinations of the first and second segmentations, am input device to receive from a user a selection for a first of the regions, and a user interaction module to emphasize the first region in the user interface

### BRIEF DESCRIPTION OF THE DRAWINGS

FIG. 1 is a schematic illustration of an example diagnostic imaging system within which the example methods, apparatus and articles of manufacture described herein may be implemented.

FIG. 2 illustrates an example image lifecycle management flow within which the example methods, apparatus and articles of manufacture described herein may be implemented.

FIG. 3 illustrates an example manner of implementing the example diagnostic workstation of FIG. 1.

FIG. 4 illustrates an example manner of implementing the example image processing module of FIG. 3.

FIGS. 5A, 5B, 6A, 6B, 7A and 7B illustrate example medical images demonstrating an example combining of medical image segmentations.

FIG. 8 is a flowchart representative of an example process that may be embodied as machine-accessible instructions and executed by, for example, one or more processors to implement the example diagnostic workstation of FIGS. 1 and 3.

FIG. 9 is a schematic illustration of an example processor platform that may be used and/or programmed to execute the example machine-accessible instructions represented in FIG. 8 to implement the example methods, apparatus and articles of manufacture described herein.

### DETAILED DESCRIPTION

In the interest of brevity and clarity, throughout the following disclosure references will be made to an example diagnostic imaging workstation 105. However, the methods, apparatus and articles of manufacture described herein to combine segmentations of medical diagnostic images may be implemented by and/or within any number and/or type(s) of additional and/or alternative diagnostic imaging systems. For example, the methods, apparatus and articles of manufacture described herein could be implemented by or within a device and/or system that captures diagnostic images (e.g., a computed tomography (CT) imaging system, magnetic resonance imaging (MRI) system, an X-ray imaging system, and/or an ultrasound imaging system), and/or by or within a system and/or workstation designed for use in viewing, analyzing, storing and/or archiving diagnostic images (e.g., the GE® picture archiving and communication system (PACS), and/or the GE advanced workstation (AW)). Further, while the example methods, apparatus and articles of manufacture are described herein with reference to two-dimensional (2D) images or datasets, the disclosed examples may be used to combine segmentations of one-dimensional (1D), three-dimensional (3D), four-dimensional (4D), etc. images or datasets.

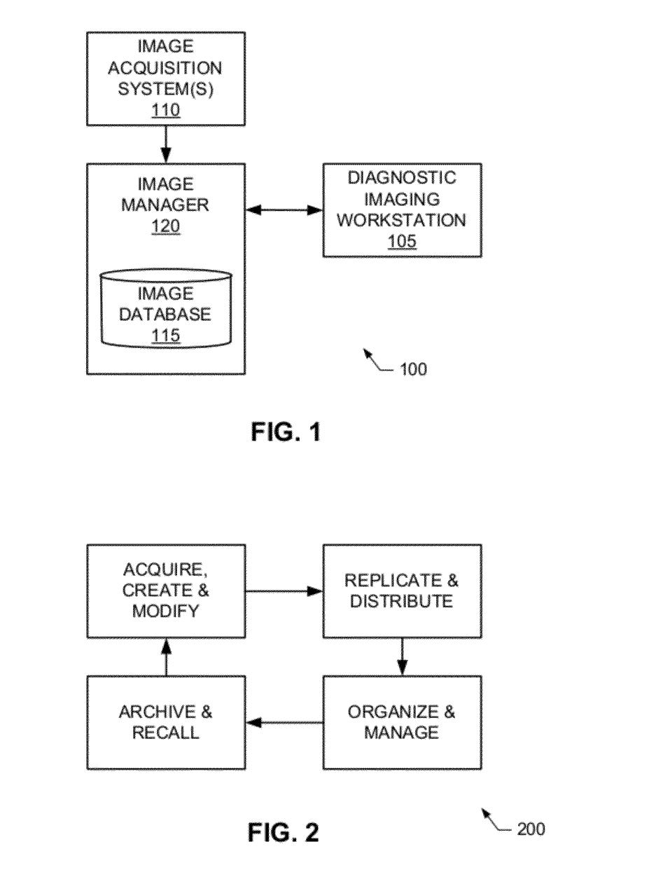

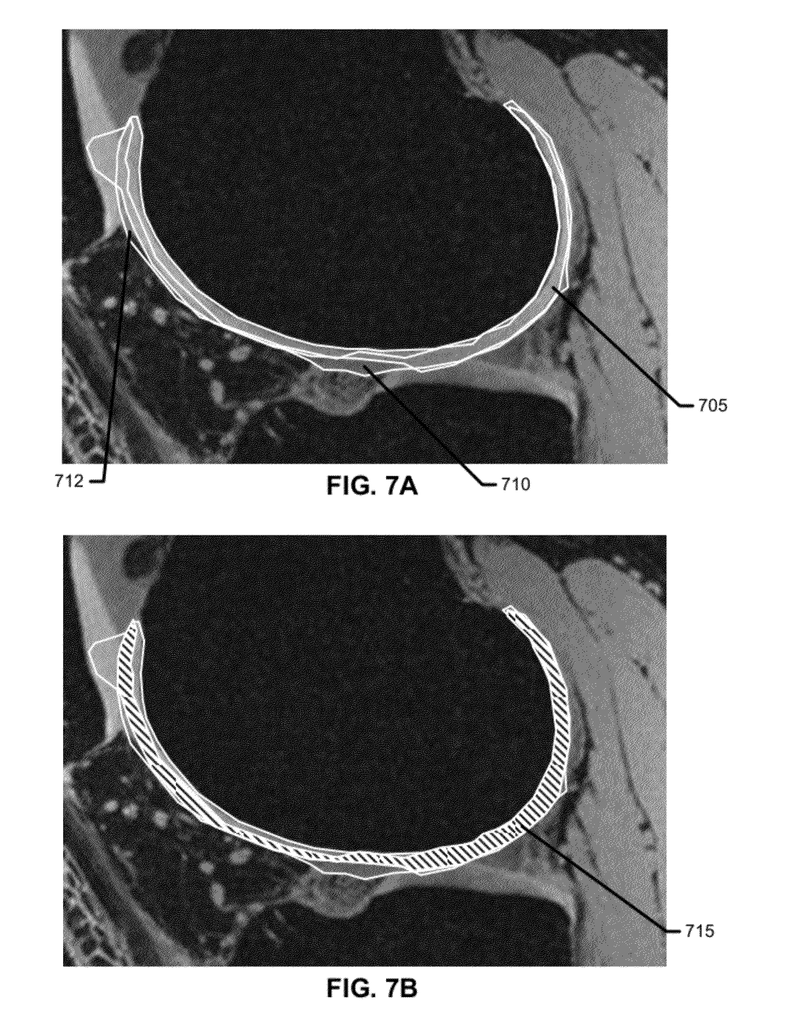

FIG. 1 illustrates an example diagnostic imaging system 100 including the example diagnostic imaging workstation 105 to combine segmentations of medical diagnostic images (e.g., FIGS. 5A and 5B). The medical diagnostic images may be captured by any number and/or type(s) of image acquisition system(s) 110, and stored in any number and/or type(s) of image database(s) 115 managed by any number and/or type(s) of image manager(s) 120. Example image acquisition systems 110 include, but are not limited to, an X-ray imaging system, an Ultrasound imaging system, a CT imaging system and/or an MRI system. Images may be stored and/or archived in the example image 115 of FIG. 1 using any number and/or type(s) of data structures, and the example image database 115 may be implemented using any number and/or type(s) of volatile and/or non-volatile memory(-ies), memory device(s) and/or storage device(s) such as a hard disk drive, a compact disc (CD), a digital versatile disc (DVD), etc.

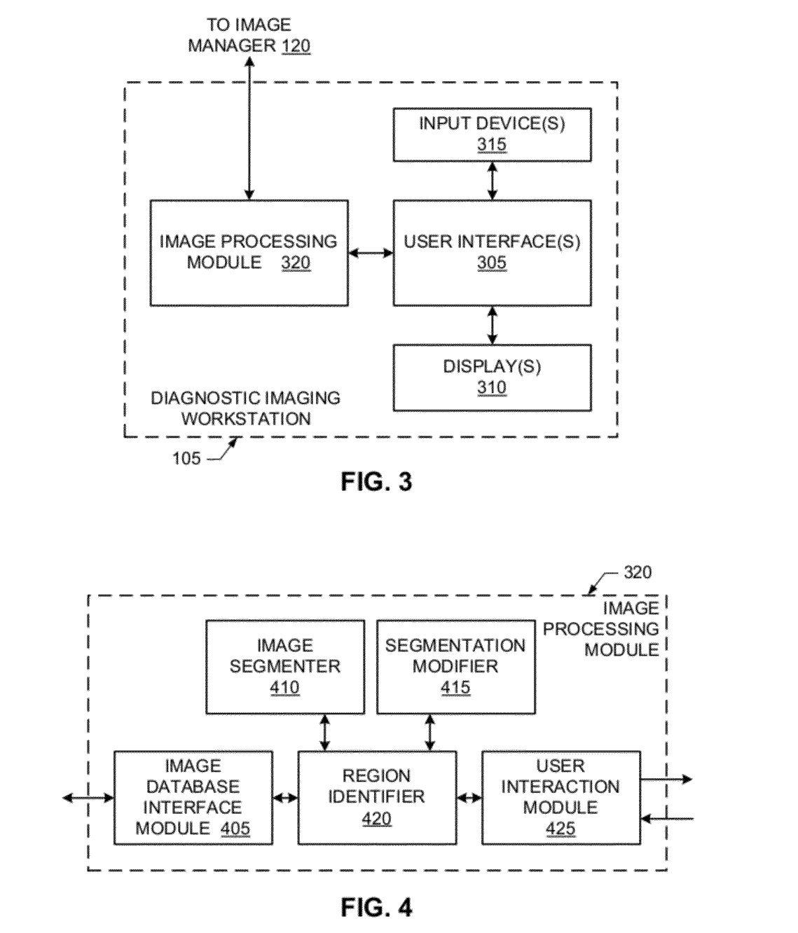

FIG. 2 illustrates an example image lifecycle management flow 200 that may be implemented by the example diagnostic imaging system 100 of FIG. 1. Medical diagnostic images (e.g., FIGS. 5A and 5B) are acquired, created and/or modified by the image acquisition system(s) 110. The image manager(s) 120 replicate, distribute, organize and/or otherwise manage the captured images. The example diagnostic imaging workstation 105 of FIG. 1, among other things, enables a user to combine multiple image segmentations of the same or different medical diagnostic images (e.g., FIGS. 6A and 6B). A combined segmentation created, computed and/or otherwise determined during the combining of segmentations via the diagnostic imaging workstation 105 (e.g., FIG. 7B) can be used to reduce the number of image(s) and/or the amount of data that must be stored, archived and/or otherwise maintained for future recall.

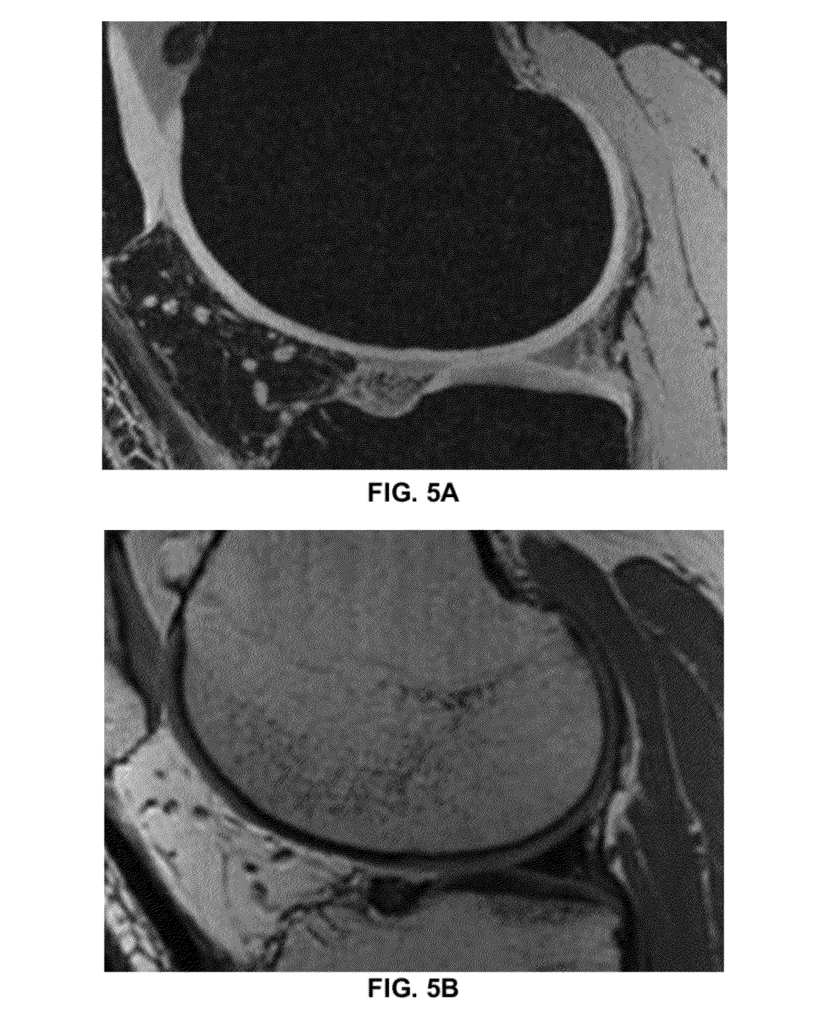

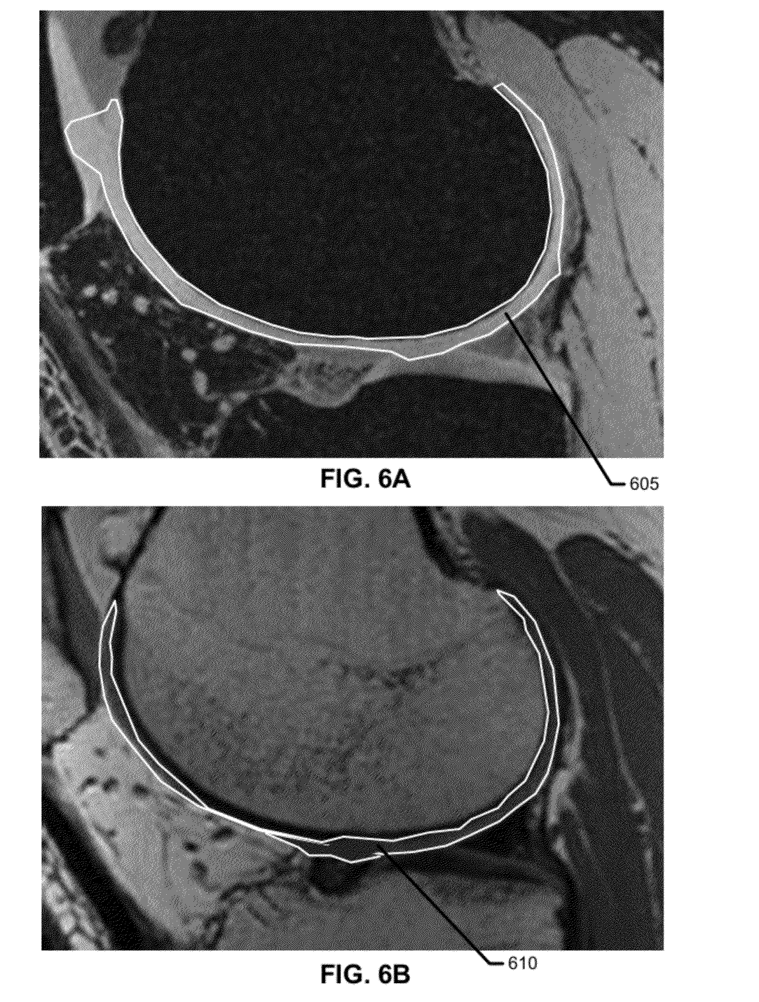

FIG. 3 is a schematic illustration of an example diagnostic imaging workstation within which the example methods, apparatus and articles of manufacture to combine segmentations of medical diagnostic images described herein may be implemented. To allow a user (not shown) to interact with the example diagnostic imaging workstation 105 of FIG. 3, the diagnostic imaging workstation 105 includes any number and/or type(s) of user interface module(s) 305, any number and/or type(s) of display(s) 310 and any number and/or type(s) of input device(s) 315. The example user interface module(s) 305 of FIG. 3 implements an operating system to present user interfaces presenting information (e.g., images, segmentations, account information, patient information, windows, screens, interfaces, dialog boxes, etc.) at the display(s) 310, and to allow a user to control, configure and/or operate the example diagnostic imaging workstation 105. The user provides and/or makes inputs and/or selections to the user interface module 305 and/or, more generally, to the example diagnostic imaging workstation 105 via the input device(s) 315. Example input devices 315 include, but are not limited to, a keyboard, a touch screen and/or a mouse. In an example, a patient search window is presented at the display 310, and the input device(s) 315 are used to enter search criteria to identify a particular patient. When a patient is identified and selected, the example user interface 305 presents a list of available medical diagnostic images for the patient at the display 310, and the user selects one or more images using the input device(s) 315. An image processing module 320 obtains the selected image(s) from the example image manager 120. The image-processing module 320 processes (e.g., segments) the selected image(s), and simultaneously or substantially simultaneously (e.g., accounting for processor and/or memory access delay(s)) presents two or more segmentations to enable the user to interactively combine the segmentations. An example manner of implementing the example image processing module 320 is described below in connection with FIG. 4.

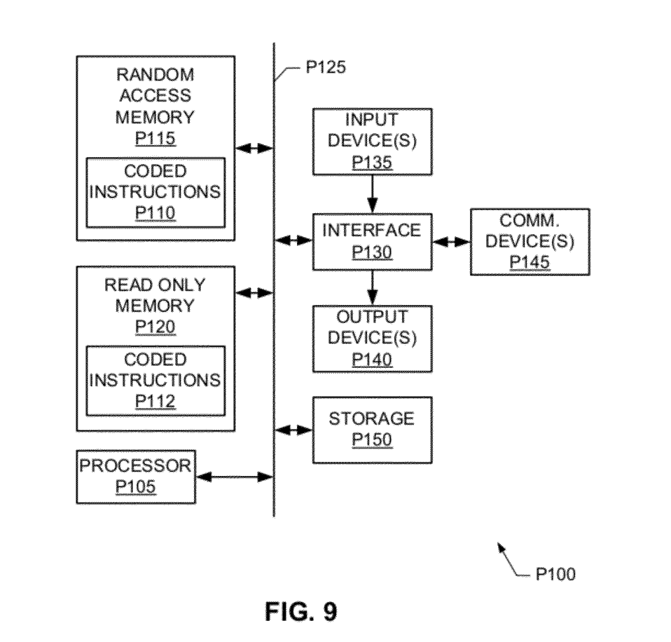

While an example manner of implementing the example diagnostic imaging workstation 105 of FIG. 1 has been illustrated in FIG. 3, one or more of the elements, processes and/or devices illustrated in FIG. 3 may be combined, divided, re-arranged, omitted, eliminated and/or implemented in any other way. Further, the example user interface(s) 305, the example display(s) 310, the example input device(s) 315, the example image processing module 320 and/or the example diagnostic imaging workstation 105 of FIGS. 1 and 3 may be implemented by hardware, software, firmware and/or any combination of hardware, software and/or firmware. Thus, for example, any of the example user interface(s) 305, the example display(s) 310, the example input device(s) 315, the example image processing module 320 and/or the example diagnostic imaging workstation 105 could be implemented by the example processor platform P100 of FIG. 9 and/or one or more circuit(s), programmable processor(s), application specific integrated circuit(s) (ASIC(s)), programmable logic device(s) (PLD(s)) and/or field programmable logic device(s) (FPLD(s)), field-programmable gate array(s) (FPGA(s)), fuses, etc. When any apparatus claim of this patent incorporating one or more of these elements is read to cover a purely software and/or firmware implementation, at least one of the example user interface(s) 305, the example display(s) 310, the example input device(s) 315, the example image processing module 320 and/or the example diagnostic imaging workstation 105 are hereby expressly defined to include a tangible article of manufacture such as a tangible computer-readable medium storing the firmware and/or software. Further still, the example diagnostic imaging workstation 105 may include one or more elements, processes and/or devices in addition to, or instead of, those illustrated in FIGS. 1 and 3, and/or may include more than one of any or all of the illustrated elements, processes and devices.

As used herein, the term tangible computer-readable medium is expressly defined to include any type of computer-readable medium and to expressly exclude propagating signals. Example computer-readable medium include, but are not limited to, a volatile or non-volatile memory, a volatile or non-volatile memory device, a CD, a DVD, a floppy disk, a read-only memory (ROM), a random-access memory (RAM), a programmable ROM (PROM), an electronically-programmable ROM (EPROM), an electronically-erasable PROM (EEPROM), an optical storage disk, an optical storage device, magnetic storage disk, a magnetic storage device, a cache, and/or any other storage media in which information is stored for any duration (e.g., for extended time periods, permanently, brief instances, for temporarily buffering, and/or for caching of the information) and which can be accessed by a processor, a computer and/or other machine having a processor, such as the example processor platform P100 discussed below in connection with FIG. 9. As used herein, the term non-transitory computer-readable medium is expressly defined to include any type of computer-readable medium and to exclude propagating signals.

FIG. 4 illustrates an example manner of implementing the example image processing module 320 of FIG. 3. To obtain medical diagnostic images, the example image processing module 320 of FIG. 4 includes an image database interface module 405. Using any number and/or type(s) of message(s), packet(s) and/or application programming interface(s), the example image database interface module 405 of FIG. 4 interacts with the example image manager 120 to obtain one or more medical diagnostic images selected by a user via, for example, the example user interface(s) 305 and/or the example input device(s) 315. Example images that may be obtained by the image database interface 405 are shown in FIGS. 5A and 5B. FIGS. 5A and 5B show two different magnetic resonance (MR) images taken using different scan techniques of the same patient's knee joint.

Returning to FIG. 4, to segment medical diagnostic images, the example image processing module 320 of FIG. 4 includes any number and/or type(s) of image segmenters, one of which is designated at reference numeral 410. Using any number and/or type(s) of method(s), algorithm(s), and/or logic, the example image segmenter 410 of FIG. 4 processes medical diagnostic images in an attempt to automatically identify one or more portions of the images (e.g., heart cavity wall, cartilage, etc.). In some examples, multiple segmentations are formed for the same medical diagnostic image as the outputs of the example image segmenter 410 after different numbers of iterations of an image segmentation algorithm. In some examples, images obtained from the image manager 120 have been previously segmented. Example articular cartilage segmentations 605 and 610 of the example images of FIGS. 5A and 5B are shown in FIGS. 6A and 6B, respectively. As shown in FIGS. 6A and 6B, the segmentations 605 and 610 are different and neither provides a suitable overlap with the patient's articular cartilage.

Returning to FIG. 4, to form a second segmentation based on a first segmentation, the example image processing module 320 includes a segmentation modifier 415. The example segmentation modifier 415 of FIG. 4 computes one or more morphological variants of a previously computed segmentation. Example morphological variants that may be computed by the example segmentation modifier 415 include, but are not limited to, eroding (e.g., scaling to x % of original size, where x<100) and/or dilating (e.g., scaling to x % of original size, where x>100).

To identify segmentation regions, the example image processing module 320 of FIG. 4 includes a region identifier 420. The example region identifier 420 of FIG. 4 spatially registers (e.g., aligns and scales) the two or more segmentations and their underlying medical diagnostic image(s), and identifies regions corresponding to various logical combinations of the two or more segmentations. In some examples, the identified regions are mutually exclusive and represent various logical combinations of the segmentations such as, for example, the intersection of A and B, the intersection of A and NOT B, and/or the intersection of NOT A and B. Additionally or alternatively, disjoint, distinct or unconnected sub-regions of each the identified region may be identified to provide a user with finer granularity during segmentation combining.

FIG. 7A illustrates an example depiction of the example image of FIG. 5A overlaid with outlines of the example segmentations 605 and 610 of FIGS. 6A and 6B. As shown in FIG. 7A, the example segmentations partially overlap. A first example region 705 represent a region included in both of the segmentations 605 and 610, and example regions 710 and 712 represents portions of the segmentation 605 that do not overlap the segmentation 610. The example regions 710 and 712 represent disjoint, distinct or unconnected sub-regions of the intersection of segmentation 605 and NOT the segmentation of segmentation 610.

Returning to FIG. 4, to present the overlaid registered segmentations and image(s), the example image processing module 320 of FIG. 4 includes a user interaction module 425. The example user interaction module 425 of FIG. 4 presents via the user interface(s) 350 and the display(s) 310 the segmentations and image(s) as, for example, shown in FIG. 7A.

The example user interaction module 425 enables a user to, for example, use a mouse 315 to select (e.g., click-on) each of the various mutually exclusive regions 705, 710 of FIG. 7A to add and/or remove them from a combined segmentation 715 (FIG. 7B). As the user selects and/or deselects regions 705, 710, the user interaction module 425 updates the display of the segmentations and image(s) to allow the user to review the effect of their selections and de-selections. As shown in FIG. 7B, a combined segmentation 715 need not include all of the original segmentations 605 and 610. The user can continue interacting with the user interaction module 425 to add and/or remove regions until they are satisfied with the resulting segmentation. Once the user is satisfied with the combined segmentation 715, the user interface module 425 stores the combined segmentation 715 in the image database 115 via the image database interface module 405.

While an example manner of implementing the example image processing module 320 of FIG. 3 is illustrated in FIG. 4, one or more of the elements, processes and/or devices illustrated in FIG. 4 may be combined, divided, re-arranged, omitted, eliminated and/or implemented in any other way. Further, the example image database interface module 405, the example image segmenter 410, the example segmentation modifier 415, the example region identifier 420, the example user interaction module 425 and/or the example image processing module 320 of FIGS. 3 and 4 may be implemented by hardware, software, firmware and/or any combination of hardware, software and/or firmware. Thus, for example, any of the example image database interface module 405, the example image segmenter 410, the example segmentation modifier 415, the example region identifier 420, the example user interaction module 425 and/or the example image processing module 320 could be implemented by the example processor platform P100 of FIG. 9 and/or one or more circuit(s), programmable processor(s), ASIC(s), PLD(s) and/or FPLD(s), FPGA(s), fuses, etc. When any apparatus claim of this patent incorporating one or more of these elements is read to cover a purely software and/or firmware implementation, at least one of the example image database interface module 405, the example image segmenter 410, the example segmentation modifier 415, the example region identifier 420, the example user interaction module 425 and/or the example image processing module 320 are hereby expressly defined to include a tangible article of manufacture such as a tangible computer-readable medium storing the firmware and/or software. Further still, the example image processing module 320 may include one or more elements, processes and/or devices in addition to, or instead of, those illustrated in FIG. 4, and/or may include more than one of any or all of the illustrated elements, processes and devices.

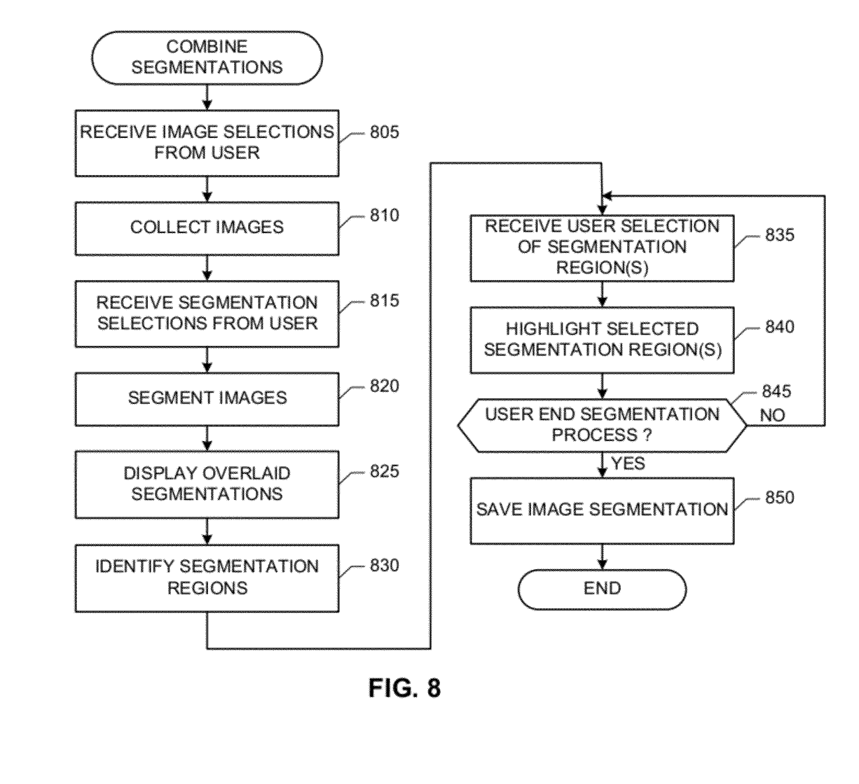

FIG. 8 is a flowchart representing an example process that may be embodied as machine-accessible instructions and executed by, for example, one or more processors to implement the example image processing module 320 of FIG. 3. A processor, a controller and/or any other suitable processing device may be used, configured and/or programmed to execute the example machine-readable instructions represented in FIG. 8. For example, the machine-readable instructions of FIG. 8 may be embodied in coded instructions stored on a tangible computer-readable medium. Machine-readable instructions comprise, for example, instructions that cause a processor, a computer and/or a machine having a processor to perform one or more particular processes. Alternatively, some or all of the example processes of FIG. 8 may be implemented using any combination(s) of ASIC(s), PLD(s), FPLD(s), FPGA(s), discrete logic, hardware, firmware, etc. Also, some or all of the example processes of FIG. 8 may be implemented manually or as any combination of any of the foregoing techniques, for example, any combination of firmware, software, discrete logic and/or hardware. Further, many other methods of implementing the example operations of FIG. 8 may be employed. For example, the order of execution of the blocks may be changed, and/or one or more of the blocks described may be changed, eliminated, sub-divided, or combined. Additionally, the blocks of the example processes of FIG. 8 may be carried out sequentially and/or carried out in parallel by, for example, separate processing threads, processors, devices, discrete logic, circuits, etc.

The example process of FIG. 8 begins with the example user interface(s) 350 receiving image selection(s) from a user via the example input device(s) 315 (block 805). The example image database interface module 405 collects the selected image(s) from the example image manager 120 (block 810).

In some examples, the user interface(s) 350 prompts the user via the display(s) 310 to provide image segmentation selections. For example, the user may select two or more different segmentation algorithms to be applied, to use previous segmentation results stored by the image manager 120, and/or one or more different morphological operations (e.g., erode or dilate) to be applied to a computed and/or previously stored segmentation. Based on segmentation selections received from the user (block 815), the example image segmenter 410 and/or the example segmentation modifier 415 segments the selected image(s) (block 820).

The example user interaction module 425 presents via the display(s) 310, the image(s) and the segmentations (e.g., as shown in FIG. 7A) (block 825). The example region identifier 420 identifies one or more regions of the display that may be individually selected and/or deselected by the user to form a combined segmentation (block 830).

As region selections are received from the user (block 835), the user interaction module 425 updates the combined segmentation 715 (FIG. 7B) by, for example, highlighting or coloring selection regions and not highlighting or coloring unselected regions (block 840). When the user indicates they are done updating the combined segmentation 715 (block 845), the user interaction module 425 stores the combined segmentation 715 in the image manager 120 via the image database interface module 405 (block 850). Control then exits from the example process of FIG. 8.

FIG. 9 is a block diagram of an example processor platform P100 capable of executing the example instructions of FIG. 8 to implement the example image processing module 320 and/or the example diagnostic imaging workstation 105 of FIGS. 1, 2 and 4. The example processor platform P100 can be, for example, a PC, a workstation, a laptop, a server and/or any other type of computing device containing a processor.

The processor platform P100 of the instant example includes at least one programmable processor P105. For example, the processor P105 can be implemented by one or more Intel® microprocessors from the Pentium® family, the Itanium® family or the XScale® family. Of course, other processors from other processor families and/or manufacturers are also appropriate. The processor P105 executes coded instructions P110 and/or P112 present in main memory of the processor P105 (e.g., within a volatile memory P115 and/or a non-volatile memory P120) and/or in a storage device P150. The processor P105 may execute, among other things, the example machine-accessible instructions of FIGS. 3-6 to implement NF-TCP. Thus, the coded instructions P110, P112 may include the example instructions of FIG. 8.

The processor P105 is in communication with the main memory including the non-volatile memory P110 and the volatile memory P115, and the storage device P150 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of RAM device. The non-volatile memory P110 may be implemented by flash memory and/or any other desired type of memory device. Access to the memory P115 and the memory P120 may be controlled by a memory controller.

The processor platform P100 also includes an interface circuit P130. Any type of interface standard, such as an external memory interface, serial port, general-purpose input/output, as an Ethernet interface, a universal serial bus (USB), and/or a PCI express interface, etc, may implement the interface circuit P130.

The interface circuit P130 may also includes one or more communication device(s) 145 such as a network interface card to communicatively couple the processor platform P100 to, for example, the example imaging manager 120 of FIG. 1.

In some examples, the processor platform P100 also includes one or more mass storage devices P150 to store software and/or data. Examples of such storage devices P150 include a floppy disk drive, a hard disk drive, a solid-state hard disk drive, a CD drive, a DVD drive and/or any other solid-state, magnetic and/or optical storage device. The example storage devices P150 may be used to, for example, store the example coded instructions of FIG. 8 and/or the example image database 115 of FIG. 1.

Generally, computer-executable instructions include routines, programs, objects, components, data structures, etc., that perform particular tasks or implement particular abstract data types. Computer-executable instructions, associated data structures, and program modules represent examples of program code for executing the processes to implement the example methods and systems disclosed herein. The particular sequence of such executable instructions and/or associated data structures represent examples of corresponding acts for implementing the examples described herein.

The example methods and apparatus described herein may be practiced in a networked environment using logical connections to one or more remote computers having processors. Example logical connections include, but are not limited to, a local area network (LAN) and a wide area network (WAN). Such networking environments are commonplace in office-wide or enterprise-wide computer networks, intranets and the Internet and may use a wide variety of different communication protocols. Such network computing environments may encompass many types of computer system configurations, including personal computers, hand-held devices, multi-processor systems, microprocessor-based or programmable consumer electronics, network PCs, minicomputers, mainframe computers, and the like. The example methods and apparatus described herein may, additionally or alternatively, be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
presenting a user interface displaying a first segmentation of a first diagnostic image together with a second segmentation of a second diagnostic image;
identifying one or more regions defined by one or more logical combinations of the first and second segmentations;
receiving from a user a selection of a first of the regions; and
emphasizing the first region in the user interface.

2. A method as defined in claim 1, further comprising:
receiving from the user a selection of a second one of the regions; and
emphasizing the second region in the user interface.

3. A method as defined in claim 1, further comprising saving the first region as a third segmentation for at least one of the first or second diagnostic images.

4. A method as defined in claim 1, wherein the second diagnostic image is different from the first diagnostic image.

5. A method as defined in claim 1, wherein the second diagnostic image comprises the first diagnostic image, and further comprising computing the first and second segmentations using different algorithms.

6. A method as defined in claim 1, wherein the second diagnostic image comprises the first diagnostic image, and further comprising computing the first segmentation by applying a morphological operation to the second segmentation.

7. A method as defined in claim 1, wherein the second diagnostic image comprises the first diagnostic image, the first segmentation corresponds to a first iteration of a segmentation algorithm, and the second segmentation corresponds to a second iteration of the segmentation algorithm.

8. A method as defined in claim 1, wherein the second diagnostic image is a different type of diagnostic image than the first diagnostic image.

9. An apparatus comprising:
a display to present a user interface displaying a first segmentation of a first diagnostic image together with a second segmentation of a second diagnostic image;
a region identifier to identify one or more regions defined by one or more logical combinations of the first and second segmentations;
an input device to receive from a user a selection for a first of the regions; and
a user interaction module to emphasize the first region in the user interface.

10. An apparatus as defined in claim 9, further comprising:
a database interface to obtain the first and second images from a diagnostic image database; and
an image segmenter to compute the first and second image segmentations.

11. An apparatus as defined in claim 9, further comprising a segmentation modifier to compute the second segmentation by applying a morphological operation to the first segmentation.

12. An apparatus as defined in claim 9, wherein the apparatus is to save the first region as a third segmentation for at least one of the first or second diagnostic images.

13. An apparatus as defined in claim 9, wherein the second diagnostic image is different from the first diagnostic image.

14. An apparatus as defined in claim 9, wherein the second diagnostic image comprises the first diagnostic image, and further comprising an image segmenter to compute the first and second image segmentations using different algorithms.

15. An apparatus as defined in claim 9, wherein the second diagnostic image comprises the first diagnostic image, the first segmentation corresponds to a first iteration of a segmentation algorithm, and the second segmentation corresponds to a second iteration of the segmentation algorithm.

16. A tangible article of manufacture storing machine-readable instructions that, when executed, cause a machine to at least:
present a user interface displaying a first segmentation of a first diagnostic image together with a second segmentation of a second diagnostic image;
identify one or more regions defined by one or more logical combinations of the first and second segmentations;
receive from a user a selection of a first of the regions; and
emphasize the first region in the user interface

17. An article of manufacture as defined in claim 16, wherein the second diagnostic image comprises the first diagnostic image.

18. An article of manufacture as defined in claim 16, wherein the second diagnostic image comprises the first diagnostic image, and the machine-readable instructions, when executed, cause the machine to compute the first and second segmentations using different algorithms.

19. An article of manufacture as defined in claim 16, wherein the second diagnostic image comprises the first diagnostic image, and the machine-readable instructions, when executed, cause the machine to compute the first segmentation by applying a morphological operation to the second segmentation.

20. An article of manufacture as defined in claim 16, wherein the second diagnostic image comprises the first diagnostic image, the first segmentation corresponds to a first iteration of a segmentation algorithm, and the second segmentation corresponds to a second iteration of the segmentation algorithm.
